(19) United States
(12) Patent Application Publication
(10) Pub. No.: US 2025/0389345 A1
(43) Pub. Date: Dec. 25, 2025

(54) DETECTING PASSING VALVES

(71) Applicant: Saudi Arabian Oil Company, Dhahran (SA)

(72) Inventors: Ali J. Alrasheed, Thuwal (SA); Sahejad Patel, Thuwal (SA); Amjad Felemban, Thuwal (SA)

(21) Appl. No.: 18/751,806

(22) Filed: Jun. 24, 2024

(51) Int. Cl. F16K 37/00; G01M 3/28

(52) U.S. Cl. CPC F16K 37/0083; G01M 3/2876

(57) ABSTRACT

Systems and methods for detecting passing valves include an acoustic emission sensor configured to detect acoustic emissions from a valve in a pipe system; an infrared camera configured to capture thermal images of the valve; and a computer system. The passing valve can be detected by obtaining acoustic emission data from the acoustic emission sensor and infrared thermography data from the infrared camera; generating fused data by fusing together the acoustic emission data and the infrared thermography data; determining that the valve is a passing valve using a machine learning model that takes as input the fused data and generates as output the determination; and determining a severity of the passing valve, a defect causing the passing valve, and a location of the defect based on the fused data.

### TECHNICAL FIELD

The present disclosure relates to methods and systems for detecting passing valves.

### BACKGROUND

Oil and gas plants include a multitude of pipes and valves to transport fluids throughout the plant. In normal operation of a valve, the valve has an open position to allow fluid to flow through the valve and a closed position to block fluid from flowing through the valve. A passing valve, however, allows a portion of the fluid to pass the valve when the valve is in a closed position. Passing valves can be caused by human error by not closing a valve completely and/or due to degradation or damage to the valve. Leakages caused by passing valves can be costly for the environment, operator health, and business profitability.

### SUMMARY

Valves can be critical components in industrial processes, and the proper functioning of valves can be essential for safety and efficiency of the industrial processes. The health of the valves can be more critical when the valve is connected directly to flare stack. Unintentional passing of gases to a flare system in oil and gas plants is a common issue that can result in environmental hazards and significant business losses. Gases that are produced during the oil and gas production processes are often burned off in the flare system to reduce the amount of gas that is released into the atmosphere. Passing valves can allow gases that are not meant to be burned to flow to the flare system resulting in a significant loss of valuable resources. In addition to resource and business losses, unintentionally passing gases in the flare system can also pose environmental hazards. The gases that escape into the atmosphere can contribute to air pollution, negatively impacting human health, wildlife, and the environment.

This disclosure describes systems and methods for detecting passing valves. Detecting passing valves and quantifying defects in passing valves can preserve resources and improve the operating efficiency of oil and gas plants by reducing wasted product. Automatically detecting these quantities using sensors can provide timely interventions to correct the passing valve. Sensors can include, for example, acoustic emission sensors (e.g., piezoelectric sensors) and temperature sensors (e.g., thermal cameras, infrared cameras, temperature probes). The sensors can be installed in locations on or near valves in pipe systems. A data processing system (e.g., a computer or control system) can combine data from the sensors using data fusion techniques. The fused data from the sensors can be processed using machine learning models to detect and quantify defects causing passing valves.

Some systems for detecting passing valves and quantifying defects in passing valves can include an acoustic emission sensor configured to detect acoustic emissions from a valve in a pipe system, an infrared camera configured to capture thermal images of the valve, and a computer system. The computer system can obtain acoustic emission data from the acoustic emission sensor and infrared thermography data from the infrared camera. The computer system can generate fused data by fusing together the acoustic emission data and the infrared thermography data. The computer system can determine that the valve is a passing valve using a machine learning model that takes as input the fused data and generates as output the determination. The computer system can determine a severity of the passing valve, a defect causing the passing valve, and a location of the defect based on the fused data. When a passing valve is detected, the computer system can perform a corrective action (e.g., closing a valve upstream of the passing valve or generating an alert indicating that the valve is a passing valve).

Implementations of the systems and methods of this disclosure can provide various technical benefits. Acoustic emission and thermography data are combined to provide a more complete characterization of the state of a valve as compared with using acoustic emission data or thermography data alone. Quantifying the severity of a passing valve and locating the defect causing the passing valve aid maintenance technicians to more efficiently resolve the passing valve. The sensors used to collect the acoustic emission data and the thermography data can be external to the pipe, independent of pressure sensors or flow sensors, and without intruding into the pipe. Passing valves can be automatically detected to enable early mitigation of the passing valves.

Integrating multimodal data (e.g., acoustic emission data and thermal image data) can capture a more comprehensive representation of the status of the valve and its surroundings, which can lead to better detection of passing valves and additional detection capabilities including flow rate and defect locations. Each type of data captures different properties and states of the valve which when the data is combined can lead to more accurate predictions. For example, acoustic emission data can capture sound, vibrations, and frequencies that can be used to detect material properties. Thermal image data can capture thermal signatures and thermal variations of the valve and spatial location information. Using the multimodal data can increase the robustness of the detection because the different data sources can adapt to different environmental conditions in different ways. For example, if there is more background noise, the quality of acoustic emission data may be degraded; however, the thermal image data would be unaffected. In another example, the thermal image data may be affected by the sun heating a valve, in which case, the acoustic data can be more reliable. Combining both types of data can also lead to better detection of slow-developing issues by monitoring and correlating the temporal and spatial data over a period of time.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 illustrates an example pipe system.

FIG. 2 is a schematic of a system for detecting passing valves and quantifying defects causing the passing valves.

FIGS. 3A, 3B, and 3C are schematics of machine learning models for detecting passing valves including data fusion.

FIG. 4 is a flowchart for a method for detecting passing valves.

FIG. 5 is a schematic illustration of a testing device for generating training data to train a machine learning model.

FIGS. 6A, 6B, and 6C illustrate various valve types for which passing valves can be detected.

FIG. 7 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

Valves can be critical components in industrial processes, and the proper functioning of valves can be essential for safety and efficiency of the industrial processes. The health of the valves can be more critical when the valve is connected directly to flare stack. Unintentional passing of gases to a flare system in oil and gas plants is a common issue that can result in environmental hazards and significant business losses. Gases that are produced during the oil and gas production processes are often burned off in the flare system to reduce the amount of gas that is released into the atmosphere. Passing valves can allow gases that are not meant to be burned to flow to the flare system resulting in a significant loss of valuable resources. In addition to resource and business losses, unintentionally passing gases in the flare system can also pose environmental hazards. The gases that escape into the atmosphere can contribute to air pollution, negatively impacting human health, wildlife, and the environment.

This disclosure describes systems and methods for detecting passing valves (e.g., valves with internal leakage). Detecting passing valves and quantifying defects in passing valves can preserve resources and improve the operating efficiency of oil and gas plants by reducing wasted product. Automatically detecting passing valves based on data collected from sensors can provide timely interventions to correct the passing valve. Sensors can include, for example, acoustic emission sensors (e.g., piezoelectric sensors) and temperature sensors (e.g., thermal cameras, infrared cameras, temperature probes). The sensors can be installed in locations on or near valves in pipe systems. Data from the sensors can be processed using machine learning models to detect and quantify the defects causing passing valves.

Some systems for detecting passing valves and quantifying defects in passing valves can include an acoustic emission sensor configured to detect acoustic emissions from a valve in a pipe system, an infrared camera configured to capture thermal images of the valve, and a computer system. The computer system can obtain acoustic emission data from the acoustic emission sensor and infrared thermography data from the infrared camera. The computer system can generate fused data by fusing together the acoustic emission data and the infrared thermography data. The computer system can determine that the valve is a passing valve using a machine learning model that takes as input the fused data and generates as output the determination. The computer system can determine a severity of the passing valve, a defect causing the passing valve, and a location of the defect based on the fused data. When a passing valve is detected, the computer system can perform a corrective action (e.g., closing a valve upstream of the passing valve or generating an alert indicating that the valve is a passing valve).

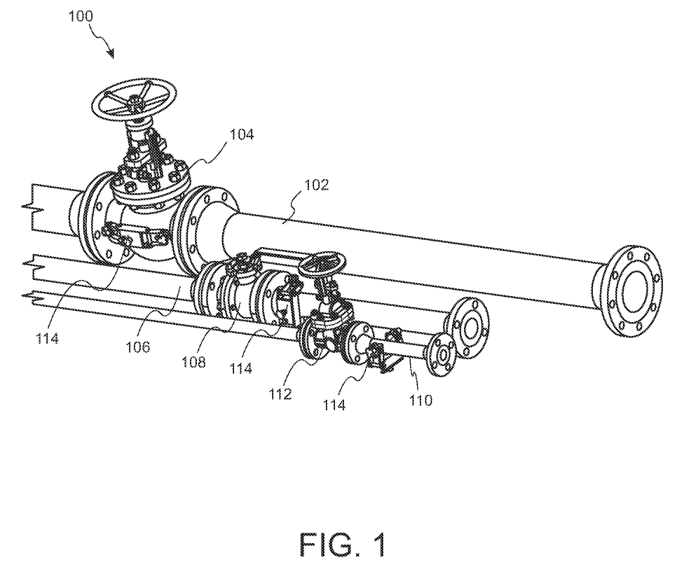

FIG. 1 is an illustration of a pipe system 100. The pipe system 100 can be used in industrial facilities such as oil and/or gas plants, refineries, chemical processing facilities, etc. The pipe system 100 includes multiple pipe diameters and valve types. The large diameter pipe 102 is coupled to a globe valve 104. The medium diameter pipe 106 is coupled to a ball valve 108. The small diameter pipe 110 is coupled to a gate valve 112. The valves 104, 108, 112 are operable to control the flow of fluid through the pipes. In a closed position, the valves 104, 108, 112 block the flow of fluid through the pipes. In an open position, the valves 104, 108, 112 allow fluid to flow through the pipes. If the valves 104, 108, 112 allow fluid to pass the valve when the valve is in the closed position, the valve is determined to be a passing valve. The valves 104, 108, 112 can be controlled electronically through a data processing system and/or the valves 104, 108, 112 can be controlled manually.

Sensor devices 114 can be deployed throughout a facility to enable real-time detection of valve leaks, preventing both environmental harm and financial losses associated with passing valves such as valves connected to a flaring system. The sensor devices 114 can include acoustic emission sensors to detect acoustic emissions from the valves 104, 108, 112. The sensor devices 114 can be positioned downstream, upstream, or on the valve body. The sensor devices 114 can also be equipped with network/wireless communications modules enabling communication of the associated valve’s status directly to a control room in order to take the appropriate corrective actions (e.g., shutting valves upstream of the passing valve, shutting down the facility, etc.). The control room can include data processing systems that remotely monitor the status of the valves 104, 108, 112.

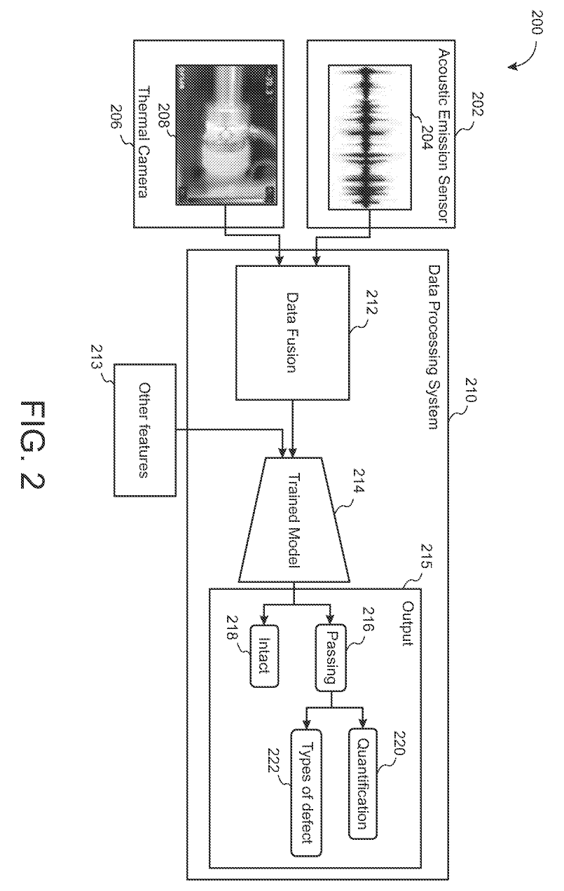

FIG. 2 is a schematic of a system 200 for detecting passing valves and quantifying defects of the passing valves. The system 200 includes an acoustic emission sensor 202, a thermal camera 206, and a data processing system 210. The data processing system 210 includes several modules that combine and process acoustic emission data 204 and thermal image data 208 to determine that a valve is a passing valve, and to determine a severity of the passing valve, a defect causing the passing valve, and a location of the defect.

The acoustic emission sensor 202 measures acoustic emission data 204. The acoustic emission sensor 202 transmits the acoustic emission data 204 to the data processing system 210 over a wired (e.g., using a coaxial cable, an ethernet cable, a USB cable) or wireless connection (e.g., Wi-Fi, cellular, short range radio communications). The acoustic emission data 204 can be, for example, a time series of magnitude of acoustic emissions. The acoustic emission sensor 202 can capture high-frequency sound waves associated with passing valves. The acoustic emission sensor 202 can detect subtle acoustic signatures that indicate defects in valves such as leaks, friction, or irregular valve operations. The acoustic emission sensor 202 can be susceptible to environmental noise that may interfere with the accuracy of the acoustic emission data 204. Based on acoustic emission data 204 alone, it can be difficult to determine a type of defect causing the passing valve.

In some implementations, the acoustic emission sensor 202 is an analog piezoelectric sensor. The acoustic emission sensor 202 can include an analog to digital converter operable to measure acoustic frequencies up to at least 2 megahertz (MHz). The acoustic emission sensor 202 can further include filters (analog or digital) to filter unwanted frequencies from the acoustic emission data 204. In some implementations, the acoustic emission sensor 202 includes an onboard computing system to process the acoustic emission data 204 prior to transmitting the acoustic emission data 204 and/or processed results (e.g., a predicted condition of the valve) to the data processing system 210.

The thermal camera 206 generates thermal image data 208 indicating the temperature of objects in the image. The thermal camera 206 is operable to detect infrared light (e.g., light having wavelengths between 1 micrometer (µm) and 14 µm). The thermal camera 206 can record single snapshot images of a valve. Additionally, or alternatively, the thermal camera 206 can record a time-series of images (e.g., a video, a time lapse). Comparing thermal image data 208 collected at two different times can reveal changes in the condition of the valve. The thermal image data 208 can capture temperature changes of the valve that can indicate a severity, a location, and/or a quantification of a passing valve. The thermal camera 206 transmits the thermal image data 208 to the data processing system 210 over a wired or wireless communications connection.

The thermal camera 206 can capture temperature variations useful for identifying overheating in a valve, friction-induced heating in a valve, or anomalies in a valve’s structure. The thermal image data 208 provides a visual representation of the valve’s thermal behavior, which can indicate a type of defect of a passing valve. In environments with high background noise, the thermal image data 208 provides a source of information that is unaffected by the acoustic challenges. Alone, the thermal image data 208, may not be as effective as acoustic emission data 204 in detecting passing valves; however, in combination, the acoustic emission data 204 and the thermal image data 208 can provide better accuracy in determining a valve’s condition than either sensor alone.

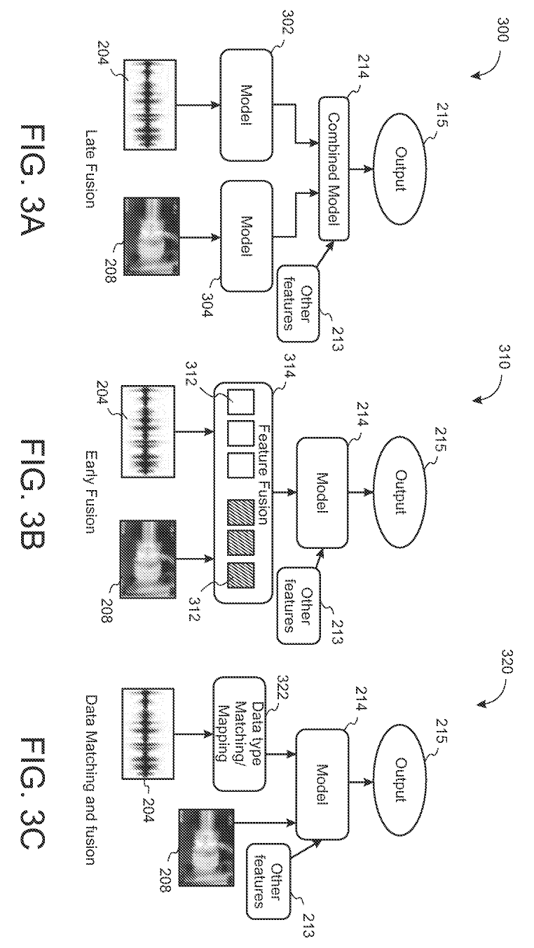

The data processing system 210 receives the acoustic emission data 204 from the acoustic emission sensor 202 and the thermal image data 208 from the thermal camera 206. The data processing system 210 combines the acoustic emission data 204 and the thermal image data 208 using the data fusion module 212. The data fusion module 212 employs data fusion techniques to combine the acoustic emission data 204 and the thermal image data 208. The acoustic emission data 204 and the thermal image data 208 provide complementary information about a valve’s operation. The acoustic emission data 204 can include information such as dynamic, high-frequency events, while the thermal image data 208 can include static, visual representations of thermal patterns of the valve. The fusion of the two data types can improve the accuracy and the robustness of the system 200 by leveraging the advantages of each type of data. Data fusion techniques are described in more detail in reference to FIGS. 3A-3C.

Fused data is passed from the data fusion module 212 to a trained machine learning model 214. The trained machine learning model 214 serves at the cognitive engine for processing the fused data from the acoustic emission sensor 202 and the thermal camera 206. The architecture of the trained machine learning model 214 can be, for example, a convolutional neural network (CNN), a long short-term memory (LSTM) model, an attention-based model, or other type of trainable model. The trained machine learning model 214 determines that a valve is a passing valve and can quantify defect of the passing valve.

A CNN model can be designed with layers specifically tailored to capture spatial patterns within thermal image data 208. Convolutions can also be applied to acoustic emission data 204 in the form of a spectrogram (e.g., an image representing a time-series of frequency and amplitude of an acoustic signal) to identify temporal patterns in the acoustic emission data 204. Data fusion can occur at a concatenation of features (e.g., horizontal, vertical, or depth concatenation) and then fed into fully connected layers for joint analysis of the fused data. A CNN architecture can be particularly effective in capturing complex spatial and temporal relationships, which can be important for understanding diverse aspects of passing valves and the associated defects.

An LSTM model includes a sequential analysis of the acoustic emission data 204 in a time-series format capturing temporal dependencies in valve sounds. A time-series of thermal image data 208 can be used to capture spatial and temporal temperature patterns. For example, the time-series of thermal image data 208 can include images of the valve at different time of the day (e.g., sunrise, morning, afternoon, sunset, night, etc.) to improve the robustness of the model. The LSTM model can combine information from both the acoustic emission data 204 and the thermal image data 208 enabling the machine learning model 214 to learn complex temporal and spatial relationships. LSTM models are well suited to handling sequential data providing insight into the dynamic nature of valve operations and defect patterns.

In an attention-based model, the model learns regions of interest in the acoustic emission data 204 and the thermal image data 208 during training. The attention-based model focuses on the regions of interest while processing the data. The attention-based model dynamically weighs features of the data based on their relevance to valve passage and defect identification. This adaptability enables the attention-based model to emphasize prominent information improving the overall performance of the model. An attention-based architecture can be effective in scenarios where certain features in the data are more indicative of passing valves and/or defects causing the passing valves thereby offering a tailored approach to processing the data.

The trained machine learning model 214 can also receive other features 213 from additional sensors and/or information about the pipe system and valve. Examples of other features include a pressure or differential pressure of the fluid in the pipe system, a temperature of the fluid, a type of the valve, a pipe diameter, and fluid property data (e.g., fluid type, density, viscosity, etc.). The other features 213 can supplement the acoustic sensor data 204 and the thermal image data 208 to aid in quantification of the defects causing the passing valve.

The trained machine learning model 214 generates output 215 including a passing 216 or intact 218 classification, quantification 220 of a passing valve, and a type of defect 222 of the passing valve. For example, the last layer of the trained machine learning model 214 can be split into two parts. The first part determines if a valve is a passing valve by predicting the presence of internal leakage in the valve. The first part can include a sigmoid activation function for a binary classification (e.g., passing 216 or intact 218). In some implementations, more than 2 classes can be used and the first part can include a softmax activation function. When a valve is determined to be a passing valve, the second part of the last layer can be a neuron without an activation function. The second part performs a regression to quantify the leakage (e.g., the amount of fluid flowing past the passing valve) indicating a severity of the passing valve. The quantification 220 of the passing valve can also utilize information from the other features 213. Quantification 220 can provide maintenance teams with information to prioritize and resolve the passing valve effectively.

The trained machine learning model 214 can generate a visualization of the defects or anomalies that cause the passing valve. The visualization can be, for example, a visual representation of the valve highlighting an area of an image that led to the prediction (e.g., most important pixel that influenced the prediction) or a heat map of anomalies. The visualization can be used to determine the type of defect 222 and/or the location of the defect. The visualization can highlight regions of the valve or aspects of the valve operation that significantly influenced the classification of the valve as a passing valve. The combination of the acoustic emission data 204 and the thermal image data 208 aids the interpretability of the trained machine learning model’s decision making process.

In some implementations, the data processing system 210 includes an explainable techniques module that can provide transparency into the machine learning model’s decision making process. The output of the explainable techniques module can include the passing valve detection along with highlighted regions within thermal images that contributed most to the detection decision. The explainable techniques module can aid operators and maintenance personnel in understanding why a valve has been indicated as a passing valve.

In some implementations, the data processing system 210 can include a transfer learning module and/or a data augmentation module. The transfer learning module can be used to fine-tune a neural network that is pretrained on a diverse dataset of thermal images. Transfer learning can decrease the time, computational resources, and iterations to train the neural network for specific applications. The data augmentation module can be used to generate synthetic training data to increase the size of the training dataset and improve the model accuracy. The data augmentation module can use generative adversarial networks (GANs) or diffusion models to generate synthetic thermal images of normal and defective valves. Both the transfer learning module and data augmentation module can adapt the trained machine learning model 214 to different valve types and valve defects.

FIGS. 3A-3C illustrate data fusion models that can be used by the data processing system 210 to fuse together the acoustic emission data 204 and the thermal image data 208. Any of the data fusion models can be implemented in the data fusion module 212 and coupled to the machine learning model 214.

FIG. 3A shows a late fusion model 300 that includes processing the acoustic emission data 204 and the thermal image data 208 through independent models 302, 304 and then combining the outputs using machine learning model 214. For example, independent model 302, which takes as input the acoustic emission data 204, can be a feature engineering based model, a neural network, an auto encoder, etc., that can compress the acoustic emission data into a small number of features. The independent model 304, which takes as input the thermal image data 208, can be a CNN, an attention model or other model that can take an image as input and output features representative of the image. This technique allows for in-depth, modality-specific analysis as each modality (e.g., acoustic emission data or thermal image data) is thoroughly examined by an independent model. The late fusion model 300 preserves the integrity of the modality-specific information until later stages of processing, facilitating the optimization of the model architecture for the specific requirements of each modality. This flexibility enables the data processing system 210 to leverage the strengths of both acoustic emission data 204 and thermal image data 208.

The independent models 302, 304 can output compressed representations of the input data. Both of the independent models 302, 304 can be trained to efficiently compress the input thermal image data 208 and the acoustic emission data into a small tensor (e.g., embedding). The two compressed tensors can be combined/fused and input into the machine learning model 214 to produce the output 215.

In some implementations, the late fusion model 300 is a decision-level fusion model, where the independent models 302, 304 generate predictions of the state of the valve (e.g., passing or intact), and the final determination is made by machine learning model 214 which takes as input the individual predictions of the independent models 302, 304 and the other features 213. This approach can enable robust decision-making by providing flexibility and adaptability to diverse data characteristics. Each modality contributes to the decision-making process independently, enabling the system to resolve discrepancies or uncertainties at the decision stage. Decision-level fusion can enhance the stability of the model's performance, making it less sensitive to variations in the individual sensor outputs.

FIG. 3B shows a feature-level fusion model 310 that includes extracting relevant features 312 independently from both the acoustic emission data 204 and the thermal image data 208 before fusing the features together. This feature-level fusion model 310 aims to improve the feature representation of the data processing system 210 by capturing unique characteristics from each sensor. The fused feature set 314 serves as a comprehensive input to the machine learning model 214, which can allow the machine learning model 214 to discern between normal and abnormal valve conditions more effectively. By incorporating intricate patterns from both sensor modalities, the feature-level fusion model can significantly contribute to the overall discriminative power of the data processing system 210.

The fused feature set 314 can be generated in a variety of ways. For example, the acoustic emission data 204 can be converted into a spectrogram, a mel-spectrogram, or other image representation, and the acoustic emission image can be concatenated with the thermal image data (e.g., forming an M x N x 6 matrix representing two color images). An alternate approach can include extracting features from the thermal image data 208 and the acoustic emission data 204 and combining or concatenating the extracted features. For example, extracted features from the acoustic emission data 204 can include a root mean square (RMS) value, Mel-Frequency Cepstral Coefficients (MFCC), signal energy, spectral roll off, a spectral bandwidth, a zero-crossing rate, etc. Extracting features from the thermal image data 208 can include using a pre-trained neural network to extract features (e.g., a vector encoding of the thermal image) from the thermal image data 208. Types of features that can be learnable by the neural network can include temperature gradients across the components in the image, edge detection boundaries between different regions of the image, hotspots or cold spots, temporal changes in a sequence of images, and anomalies that deviate from an expected (e.g., normal) temperature range.

FIG. 3C shows a data matching and fusion model 320 that includes a data type matching/mapping 322 of the acoustic emission data 204. The data type matching/mapping 322 converts the acoustic emission data 204 into a format compatible with the thermal image data 208. For example, the acoustic emission data 204 can be converted into an image representation such as a spectrogram. The machine learning model 214 takes as input the matched/mapped acoustic emission data, the thermal image data 208, and the other features 213. The data matching and fusion model 320 can enable a larger variety of model architectures to be used to detect the passing valves. For example, image based model architectures such as CNNs can be used to process the acoustic emission data 204.

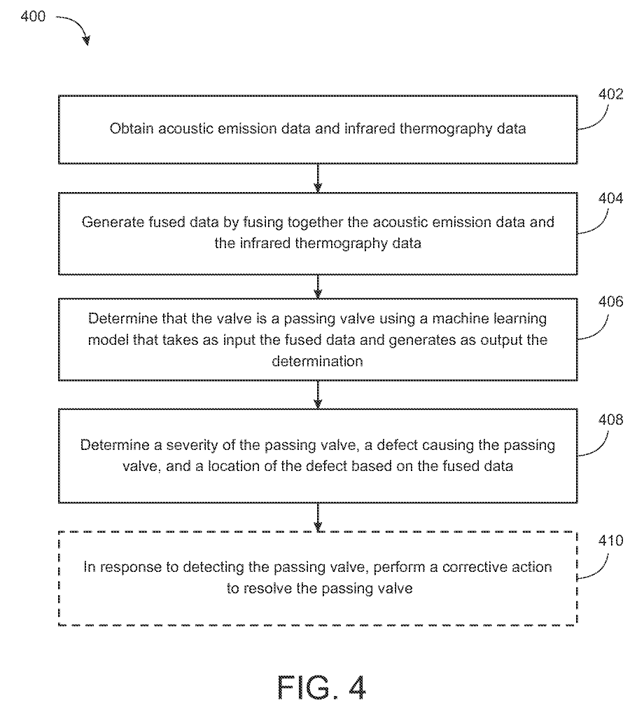

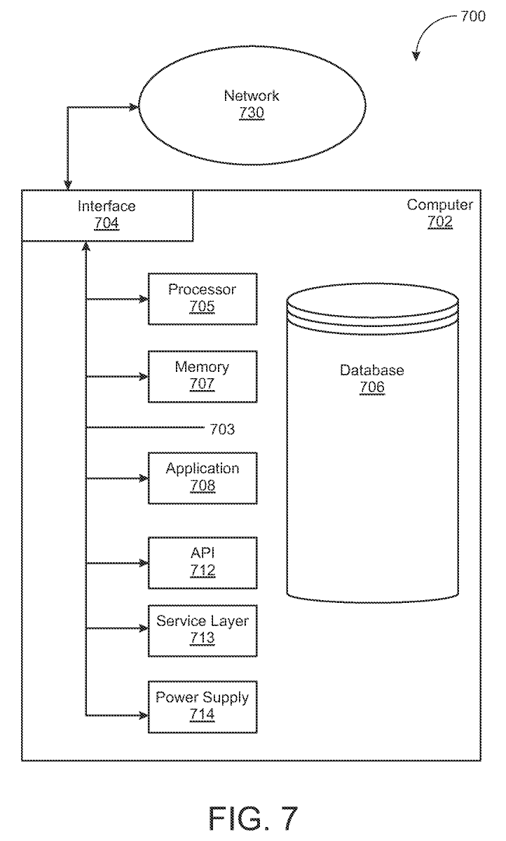

FIG. 4 is a flow chart for an example method 400 for detecting passing valves. The method 400 can be implemented on a data processing system such as a computer or control system (e.g., data processing system 210 or the computer system of FIG. 7).

The data processing system obtains acoustic emission data and infrared thermography data (step 402). For example, the data processing system can obtain the acoustic emission data from an acoustic emission sensor and the infrared thermography data from a thermal camera. In some implementations, the data processing system obtains the acoustic emission data and the infrared thermography data from a data store (e.g., accessing a data store to retrieve previously stored data).

In some implementations, the data processing system extracts features from the acoustic emission data and/or the infrared thermography data. The data processing system can extract features from the infrared thermography data such as a vector encoding of a thermal image, temperature gradients across components in the image, boundaries between different temperature regions, hotspot/cold spot detections, and temporal changes of components.

Extracting features from the acoustic emission data can include processing of the data to reduce noise and/or isolate frequencies outside a desired range. For example, the data processing system can apply a bandpass filter to the acoustic emission data. The bandpass filter attenuates frequencies outside of a specified band to isolate frequencies indicative of passing valves (e.g., 50-500 kilo Hertz (kHz), 100-300 kHz, 20-500 kHz). The lower frequency limit can be specified, for example, to attenuate anticipated low frequency noise such as noise from vibrations or sounds caused by operating machinery or sounds in the human audible range. The upper limit of the frequency range can be selected, for example, based on the sampling frequency of the sensor or a multiple of a known peak frequency.

The data processing system can extract features from the acoustic emission data including time domain features, frequency domain features, or both. Time domain features include, for example, an RMS of the acoustic emission data that gives a measure of the magnitude of the signal and a zero-crossing rate which counts the number of times that the acoustic emission data changes from a positive value to a negative value or vice versa. Frequency domain features can include, for example, spectral roll-off, spectral bandwidth, frequency with maximum amplitude, frequency with maximum time averaged amplitude, and MFCCs. Spectral roll off is a measure of the shape of the power spectrum of the acoustic emission data. In particular, it measures the frequency at which high frequencies decline to zero. Spectral Bandwidth is a weighted mean of the distances of frequency bands form the spectral centroid. Frequency value with maximum amplitude and frequency value with maximum time-average amplitude can be determined based on a spectrogram representing the acoustic emission data. MFCCs give short-term power spectrum of the acoustic emission data, which can be useful to distinguish acoustic emission data having different frequency content (e.g., passing and closed valves). For example, 5-20 MFCC coefficients can be extracted.

In some implementations, the data processing system generates a spectrogram based on the acoustic emission data. A spectrogram can represent time variation of the frequency content of a measured signal. For example, a spectrogram can be a two-dimensional image with the vertical axis representing frequency, the horizontal axis representing time and the image grayscale intensity or color values of the pixels in the image can represent the amplitude of the measured signal at the corresponding frequency and time. Including the time variation can decrease the effects of noise on the signal since external noise can be a shorter duration than the signal length. The external noise would therefore not affect each time step of the acoustic emission data and the spectrogram. Including the time variation of the signal can give the model more discriminatory power as compared with a power spectral density without time variation.

The data processing system generates fused data by fusing together the acoustic emission data and the infrared thermography data (step 404). The data processing system can generate the fused data, for example, using any of the data fusion models described in reference to FIGS. 2 and 3A-3C.

The data processing system determines that the valve is a passing valve using a machine learning model that takes as input the fused data and generates as output the determination (step 406). The machine learning model can include, for example, a convolutional neural network, a long short-term memory model, an attention-based model, or other trainable machine learning model.

The data processing system determines a severity of the passing valve, a defect causing the passing valve, and a location of the defect based on the fused data (step 408). For example, the data processing system can determine the severity of the passing valve by quantifying an amount of fluid passing by the valve. The data processing system can determine the defect and the location of the defect based on output from the machine learning model by, for example, highlighting a region in the thermal image contributing significantly to the classification.

In some implementations, in response to detecting the passing valve, the data processing system performs a corrective action to resolve the passing valve (step 410). In some implementations, the data processing system performs a corrective action including generating an alert indicating the detection of the passing valve. For example, the data processing system can generate an audible alert and/or a visual alert at the location of the passing valve. Alternatively, or additionally, the data processing system can transmit a signal to a computing device (e.g., a mobile device) that includes a display device to display an alert indicating that a passing valve was detected.

In some implementations, the data processing system performs a corrective action including automatically closing a valve upstream of the detected passing valve. For example, the data processing system can generate a control signal to electronically close a valve located upstream of the detected passing valve to prevent leaks through the passing valve.

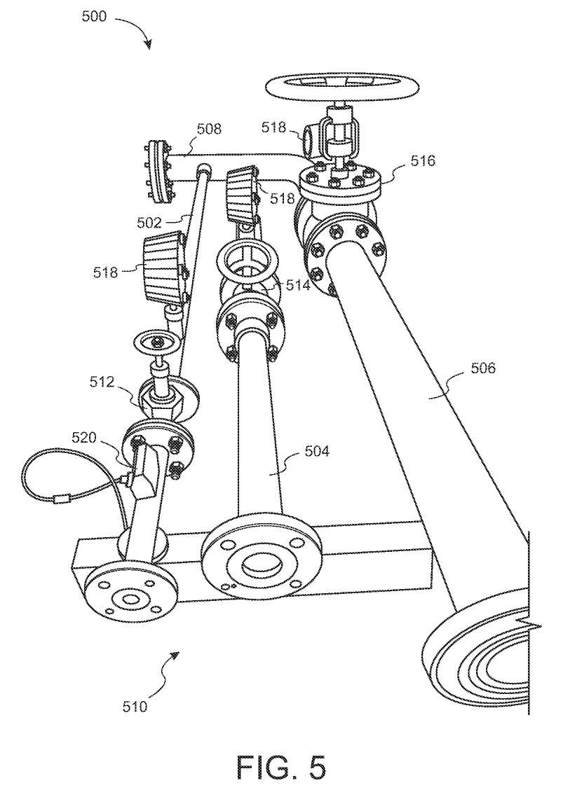

FIG. 5 is a schematic illustration of an example testing device 500 for generating training data to train the machine learning model. The testing device 500 includes 3 pipes 502-406 having different diameters. The pipes 502-406 are connected to a manifold 508 on the upstream end of the pipes. The manifold 508 is configured to distribute fluid into each pipe 502-406. The downstream ends 510 of the pipes 502-506 are open to the ambient atmosphere. The smallest diameter pipe 502 includes a gate valve 512. The medium diameter pipe 504 includes a ball valve 514. The largest diameter pipe 506 includes a globe valve 516. Each pipe 502-406 also includes a pressure sensor 518.

As shown in FIG. 5, a piezoelectric acoustic emission sensor 520 is magnetically attached to the pipe 502 downstream of and adjacent to the gate valve 512. The piezoelectric acoustic emission sensor 520 can also be magnetically attached to pipes 504 and 506 downstream of the valves 514 and 516.

A thermal camera (not shown) can be positioned to capture thermal image data of one or more of the valves 512, 514, 516 corresponding to acoustic emission data collected by the acoustic emission sensor 520.

The testing device 500 is operated by selecting one of the valves 512-416 for testing. The piezoelectric acoustic emission sensor 520 is attached to the pipe near the selected valve. The valve is configured in a chosen configuration. For example, the valve can be fully closed, partially open, or fully open. A flow of fluid is provided to the manifold 508. The fluid can be a gas (e.g., air) or a liquid (e.g., water).

A data processing system (e.g., data processing system 210) acquires training data from the testing device 500 by collecting acoustic data from the piezoelectric acoustic emission sensor 520 while fluid is being provided to the manifold 508, and capturing thermal image data from a thermal (infrared) camera. The training data includes the acoustic emission data and thermal image data labeled with a 0 for valves in a fully closed configuration (e.g., not passing or leaking) and labeled with a 1 for valves in a passing configuration (e.g., partially or fully open). Other labeling schemes are also possible. Including training data collected from multiple pipe diameters and multiple valve types and configurations helps prevent overfitting the machine learning model to a particular pipe size or valve type.

The data processing system trains the machine learning model based on the acquired training data. The training data can be divided between a training set and a test set. For example, data collected from ball valves and gate valves can form the training set and data from globe valves can form the test set. The training data can be divided between the training set and the test set in other ways also. For example, the training set and the test set can be selected randomly from the training data according to a specified ratio (e.g., 70/30 training/testing split). The data processing system optimizes the machine learning model based on the training set. The data processing system evaluates the machine learning model performance based on the test set.

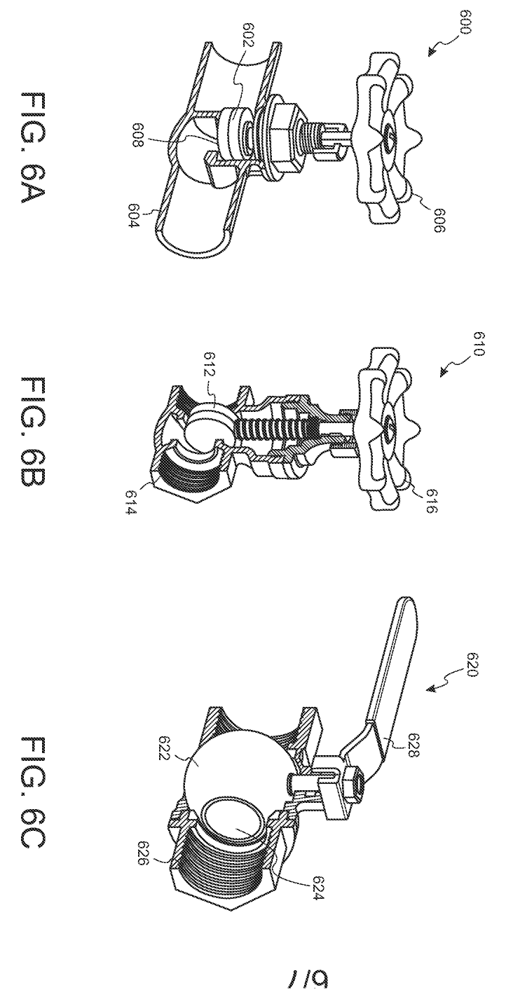

FIGS. 6A-6C show cut away illustrations of example valves 600, 610, and 620. The globe valve 600 includes a plug 602 that can be translated perpendicularly to a longitudinal axis of the pipe 604 by turning the handle 606. The plug 602 blocks an orifice 608 to prevent fluid flow through the pipe 604 when the globe valve 600 is in a fully closed position. The gate valve 610 includes a gate 612 that is perpendicular to the longitudinal axis of the pipe 614. The gate 612 is translated perpendicularly to the longitudinal axis of the pipe by rotating the handle 616. The gate 612 blocks the flow of fluid through the pipe 614 when in a fully closed position. The ball valve 620 includes a ball 622 with a hole 624 bored through the ball 622. The ball 622 can be rotated about an axis perpendicular to a longitudinal axis of the pipe 626. The ball valve 620 can be closed or opened by a quarter turn of the handle 628.

FIG. 7 is a block diagram of an example computer system 700 used to provide computational functionalities associated with described algorithms, methods, functions, processes, flows, and procedures described in the present disclosure, according to some implementations of the present disclosure. The illustrated computer 702 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 702 can include input devices such as keypads, keyboards, and touch screens that can accept user information. Also, the computer 702 can include output devices that can convey information associated with the operation of the computer 702. The information can include digital data, visual data, audio information, or a combination of information. The information can be presented in a graphical user interface (UI) (or GUI).

The computer 702 can serve in a role as a client, a network component, a server, a database, a persistency, or components of a computer system for performing the subject matter described in the present disclosure. The illustrated computer 702 is communicably coupled with a network 730. In some implementations, one or more components of the computer 702 can be configured to operate within different environments, including cloud-computing-based environments, local environments, global environments, and combinations of environments.

At a high level, the computer 702 is an electronic computing device operable to receive, transmit, process, store, and manage data and information associated with the described subject matter. According to some implementations, the computer 702 can also include, or be communicably coupled with, an application server, an email server, a web server, a caching server, a streaming data server, or a combination of servers.

The computer 702 can receive requests over network 730 from a client application (for example, executing on another computer 702). The computer 702 can respond to the received requests by processing the received requests using software applications. Requests can also be sent to the computer 702 from internal users (for example, from a command console), external (or third) parties, automated applications, entities, individuals, systems, and computers.

Each of the components of the computer 702 can communicate using a system bus 703. In some implementations, any or all of the components of the computer 702, including hardware or software components, can interface with each other or the interface 704 (or a combination of both), over the system bus 703. Interfaces can use an application programming interface (API) 712, a service layer 713, or a combination of the API 712 and service layer 713. The API 712 can include specifications for routines, data structures, and object classes. The API 712 can be either computer-language independent or dependent. The API 712 can refer to a complete interface, a single function, or a set of APIs.

The service layer 713 can provide software services to the computer 702 and other components (whether illustrated or not) that are communicably coupled to the computer 702. The functionality of the computer 702 can be accessible for all service consumers using this service layer. Software services, such as those provided by the service layer 713, can provide reusable, defined functionalities through a defined interface. For example, the interface can be software written in JAVA, C++, or a language providing data in extensible markup language (XML) format. While illustrated as an integrated component of the computer 702, in alternative implementations, the API 712 or the service layer 713 can be stand-alone components in relation to other components of the computer 702 and other components communicably coupled to the computer 702. Moreover, any or all parts of the API 712 or the service layer 713 can be implemented as child or sub-modules of another software module, enterprise application, or hardware module without departing from the scope of the present disclosure.

The computer 702 includes an interface 704. Although illustrated as a single interface 704 in FIG. 7, two or more interfaces 704 can be used according to particular needs, desires, or particular implementations of the computer 702 and the described functionality. The interface 704 can be used by the computer 702 for communicating with other systems that are connected to the network 730 (whether illustrated or not) in a distributed environment. Generally, the interface 704 can include, or be implemented using, logic encoded in software or hardware (or a combination of software and hardware) operable to communicate with the network 730. More specifically, the interface 704 can include software supporting one or more communication protocols associated with communications. As such, the network 730 or the interface's hardware can be operable to communicate physical signals within and outside of the illustrated computer 702.

The computer 702 includes a processor 705. Although illustrated as a single processor 705 in FIG. 7, two or more processors 705 can be used according to particular needs, desires, or particular implementations of the computer 702 and the described functionality. Generally, the processor 705 can execute instructions and can manipulate data to perform the operations of the computer 702, including operations using algorithms, methods, functions, processes, flows, and procedures as described in the present disclosure.

The computer 702 also includes a database 706 that can hold data for the computer 702 and other components connected to the network 730 (whether illustrated or not). For example, database 706 can be an in-memory, conventional, or a database storing data consistent with the present disclosure. In some implementations, database 706 can be a combination of two or more different database types (for example, hybrid in-memory and conventional databases) according to particular needs, desires, or particular implementations of the computer 702 and the described functionality. Although illustrated as a single database 706 in FIG. 7, two or more databases (of the same, different, or combination of types) can be used according to particular needs, desires, or particular implementations of the computer 702 and the described functionality. While database 706 is illustrated as an internal component of the computer 702, in alternative implementations, database 706 can be external to the computer 702.

The computer 702 also includes a memory 707 that can hold data for the computer 702 or a combination of components connected to the network 730 (whether illustrated or not). Memory 707 can store any data consistent with the present disclosure. In some implementations, memory 707 can be a combination of two or more different types of memory (for example, a combination of semiconductor and magnetic storage) according to particular needs, desires, or particular implementations of the computer 702 and the described functionality. Although illustrated as a single memory 707 in FIG. 7, two or more memories 707 (of the same, different, or combination of types) can be used according to particular needs, desires, or particular implementations of the computer 702 and the described functionality. While memory 707 is illustrated as an internal component of the computer 702, in alternative implementations, memory 707 can be external to the computer 702.

The application 708 can be an algorithmic software engine providing functionality according to particular needs, desires, or particular implementations of the computer 702 and the described functionality. For example, application 708 can serve as one or more components, modules, or applications. Further, although illustrated as a single application 708, the application 708 can be implemented as multiple applications 708 on the computer 702. In addition, although illustrated as internal to the computer 702, in alternative implementations, the application 708 can be external to the computer 702.

The computer 702 can also include a power supply 714. The power supply 714 can include a rechargeable or non-rechargeable battery that can be configured to be either user- or non-user-replaceable. In some implementations, the power supply 714 can include power-conversion and management circuits, including recharging, standby, and power management functionalities. In some implementations, the power-supply 714 can include a power plug to allow the computer 702 to be plugged into a wall socket or a power source to, for example, power the computer 702 or recharge a rechargeable battery.

There can be any number of computers 702 associated with, or external to, a computer system containing computer 702, with each computer 702 communicating over network 730. Further, the terms "client," "user," and other appropriate terminology can be used interchangeably, as appropriate, without departing from the scope of the present disclosure. Moreover, the present disclosure contemplates that many users can use one computer 702 and one user can use multiple computers 702.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms "data processing apparatus," "computer," and "electronic computer device" (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

Examples

In an example implementations, a system for detecting passing valves and quantifying defects in passing valves includes an acoustic emission sensor configured to detect acoustic emissions from a valve in a pipe system; an infrared camera configured to capture thermal images of the valve; and a computer system including at least one processor and a memory storing instructions that when executed by the at least one processor cause performance of operations including obtaining acoustic emission data from the acoustic emission sensor and infrared thermography data from the infrared camera; generating fused data by fusing together the acoustic emission data and the infrared thermography data; determining that the valve is a passing valve using a machine learning model that takes as input the fused data and generates as output the determination; and determining a severity of the passing valve, a defect causing the passing valve, and a location of the defect based on the fused data.

In an aspect combinable with the example implementation, the operations include in response to determining the severity of the passing valve, the defect causing the passing valve, and the location of the defect, performing a corrective action to resolve the passing valve.

In another aspect combinable with any of the previous aspects, the corrective action includes at least one of generating an alert indicating detection of the passing valve or automatically closing a valve upstream of the passing valve.

In another aspect combinable with any of the previous aspects, the operations include generating a first valve classification based on the acoustic emission data and a second valve classification based on the infrared thermography data, where generating the fused data includes combining the first valve classification and the second valve classification into an input for the machine learning model.

In another aspect combinable with any of the previous aspects, the operations include extracting features from the acoustic emission data and the infrared thermography data, where generating the fused data includes combining the extracted features to form the fused data.

In another aspect combinable with any of the previous aspects, extracting features from the acoustic emission data includes extracting one or more of a root mean square value, a spectral roll off, a spectral bandwidth, a zero-crossing rate, and Mel-Frequency Cepstral Coefficients

Another aspect combinable with any of the previous aspects includes one or more of a temperature sensor, an accelerometer, and a pressure sensor where the input to the machine learning model includes one or more of pressure data, temperature data, acceleration data, valve type data, pipe diameter data, and fluid property data.

In another aspect combinable with any of the previous aspects, the machine learning model includes a convolutional neural network, a long short-term memory model, or an attention based model.

In another aspect combinable with any of the previous aspects, determining the severity of the passing valve, the defect causing the passing valve, and the location of the defect includes using a layer in the machine learning model without an activation function after determining that the valve is a passing valve.

In another aspect combinable with any of the previous aspects, the machine learning model is a first machine learning model, and the operations include encoding the acoustic emission data using a second machine learning model; and encoding the infrared thermography data using a third machine learning model, where generating the fused data includes combining the encoded acoustic emission data and the encoded infrared thermography data.

In another aspect combinable with any of the previous aspects, encoding the acoustic emission data and the infrared thermography data includes forming a tensor representation of the acoustic emission data and a tensor representation of the infrared thermography data.

In another aspect combinable with any of the previous aspects, the acoustic emission data includes a spectrogram, the infrared thermography data includes a thermal image, and generating fused data includes concatenating the spectrogram with the thermal image.

In another aspect combinable with any of the previous aspects, the acoustic emission data includes a time-series of acoustic emission values, the infrared thermography data includes a time-series of thermal images, the machine learning model includes a long short-term memory model, and the long short-term memory model takes as input the time-series of acoustic emission values and the time-series of thermal images.

In another example implementation, a method for detecting passing valves and quantifying defects in passing valves includes obtaining acoustic emission data and infrared thermography data associated with a valve in a pipe system; generating fused data by fusing together the acoustic emission data and the infrared thermography data; determining that the valve is a passing valve using a machine learning model that takes as input the fused data and generates as output the determination; determining a severity of the passing valve, a defect causing the passing valve, and a location of the defect based on the fused data; and in response to determining the severity of the passing valve, the defect causing the passing valve, and the location of the defect, performing a corrective action to resolve the passing valve.

In an aspect combinable with the example implementation, the corrective action includes at least one of generating an alert indicating detection of the passing valve or automatically closing a valve upstream of the passing valve.

Another aspect combinable with any of the previous aspects includes generating a first valve classification based on the acoustic emission data and a second valve classification based on the infrared thermography data, where generating the fused data includes combining the first valve classification and the second valve classification into an input for the machine learning model.

Another aspect combinable with any of the previous aspects includes extracting features from the acoustic emission data and the infrared thermography data, where generating the fused data includes combining the extracted features to form the fused data.

In another aspect combinable with any of the previous aspects, extracting features from the acoustic emission data includes extracting one or more of a root mean square value, a spectral roll off, a spectral bandwidth, a zero-crossing rate, and Mel-Frequency Cepstral Coefficients

In another aspect combinable with any of the previous aspects, the machine learning model includes a convolutional neural network, a long short-term memory model, or an attention based model.

In another aspect combinable with any of the previous aspects, determining the severity of the passing valve, the defect causing the passing valve, and the location of the defect includes using a layer in the machine learning model without an activation function after determining that the valve is a passing valve.

What is claimed is:

1. A system for detecting passing valves and quantifying defects in passing valves, the system comprising:
an acoustic emission sensor configured to detect acoustic emissions from a valve in a pipe system;
an infrared camera configured to capture thermal images of the valve; and
a computer system comprising at least one processor and a memory storing instructions that when executed by the at least one processor causes performance of operations comprising:
obtaining acoustic emission data from the acoustic emission sensor and infrared thermography data from the infrared camera;
generating fused data by fusing together the acoustic emission data and the infrared thermography data;
determining that the valve is a passing valve using a machine learning model that takes as input the fused data and generates as output the determination; and
determining a severity of the passing valve, a defect causing the passing valve, and a location of the defect based on the fused data.

2. The system of claim 1, wherein the operations further comprise in response to determining the severity of the passing valve, the defect causing the passing valve, and the location of the defect, performing a corrective action to resolve the passing valve.

3. The system of claim 2, wherein the corrective action comprises at least one of generating an alert indicating detection of the passing valve or automatically closing a valve upstream of the passing valve.

4. The system of claim 1, wherein the operations further comprise:
generating a first valve classification based on the acoustic emission data and a second valve classification based on the infrared thermography data,
wherein generating the fused data comprises combining the first valve classification and the second valve classification into an input for the machine learning model.

5. The system of claim 1, wherein the operations further comprise extracting features from the acoustic emission data and the infrared thermography data, wherein generating the fused data comprises combining the extracted features to form the fused data.

6. The system of claim 1, wherein extracting features from the acoustic emission data comprises extracting one or more of a root mean square value, a spectral roll off, a spectral bandwidth, a zero-crossing rate, and Mel-Frequency Cepstral Coefficients.

7. The system of claim 1, further comprising one or more of a temperature sensor, an accelerometer, and a pressure sensor wherein the input to the machine learning model further comprises one or more of pressure data, temperature data, acceleration data, valve type data, pipe diameter data, and fluid property data.

8. The system of claim 1, wherein the machine learning model comprises a convolutional neural network, a long short-term memory model, or an attention based model.

9. The system of claim 1, wherein determining the severity of the passing valve, the defect causing the passing valve, and the location of the defect comprises using a layer in the machine learning model without an activation function after determining that the valve is a passing valve.

10. The system of claim 1, wherein the machine learning model is a first machine learning model, and wherein the operations further comprise:
encoding the acoustic emission data using a second machine learning model; and
encoding the infrared thermography data using a third machine learning model,
wherein generating the fused data comprises combining the encoded acoustic emission data and the encoded infrared thermography data.

11. The system of claim 10, wherein encoding the acoustic emission data and the infrared thermography data comprises forming a tensor representation of the acoustic emission data and a tensor representation of the infrared thermography data.

12. The system of claim 1, wherein the acoustic emission data comprises a spectrogram, the infrared thermography data comprises a thermal image, and generating fused data comprises concatenating the spectrogram with the thermal image.

13. The system of claim 1, wherein the acoustic emission data comprises a time-series of acoustic emission values, the infrared thermography data comprises a time-series of thermal images, the machine learning model comprises a long short-term memory model, and the long short-term memory model takes as input the time-series of acoustic emission values and the time-series of thermal images.

14. A method for detecting passing valves and quantifying defects in passing valves, the method comprising:
obtaining acoustic emission data and infrared thermography data associated with a valve in a pipe system;
generating fused data by fusing together the acoustic emission data and the infrared thermography data;
determining that the valve is a passing valve using a machine learning model that takes as input the fused data and generates as output the determination;
determining a severity of the passing valve, a defect causing the passing valve, and a location of the defect based on the fused data; and
in response to determining the severity of the passing valve, the defect causing the passing valve, and the location of the defect, performing a corrective action to resolve the passing valve.

15. The method of claim 14, wherein the corrective action comprises at least one of generating an alert indicating detection of the passing valve or automatically closing a valve upstream of the passing valve.

16. The method of claim 14, further comprising generating a first valve classification based on the acoustic emission data and a second valve classification based on the infrared thermography data, wherein generating the fused data comprises combining the first valve classification and the second valve classification into an input for the machine learning model.

17. The method of claim 15, further comprising extracting features from the acoustic emission data and the infrared thermography data, wherein generating the fused data comprises combining the extracted features to form the fused data.

18. The method of claim 17, wherein extracting features from the acoustic emission data comprises extracting one or more of a root mean square value, a spectral roll off, a spectral bandwidth, a zero-crossing rate, and Mel-Frequency Cepstral Coefficients.

19. The method of claim 14, wherein the machine learning model comprises a convolutional neural network, a long short-term memory model, or an attention based model.

20. The method of claim 19, wherein determining the severity of the passing valve, the defect causing the passing valve, and the location of the defect comprises using a layer in the machine learning model without an activation function after determining that the valve is a passing valve.
